(19) United States
(12) Patent Application Publication
(10) Pub. No.: US 2009/0109270 A1
(43) Pub. Date: Apr. 30, 2009

(54) INKJET RECORDING MEDIUM AND METHOD OF MANUFACTURING THE SAME

(75) Inventor: Masamichi KOBAYASHI, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/258,840

(22) Filed: Oct. 27, 2008

(30) Foreign Application Priority Data
Oct. 31, 2007 (JP) 2007-283053

(51) Int. Cl. B41J 3/407

(52) U.S. Cl. 347/106

(57) ABSTRACT

An inkjet recording medium including at least a first ink-receiving layer and a second ink-receiving layer on a support, the first ink-receiving layer being positioned farthest from the support and containing pseudo-boehmite alumina, and the second ink-receiving layer being positioned between the first ink receiving layer and the support and containing a water-soluble polyvalent metal salt and fumed silica that is dispersed using the water-soluble polyvalent metal salt.

### CROSS-REFERENCE TO RELATED APPLICATION

This application claims priority under 35 USC 119 from Japanese Patent Application No. 2007-283053, the disclosure of which is incorporated by reference herein.

### BACKGROUND OF THE INVETNION

1. Field of the Invention

The present invention relates to an inkjet recording medium, which is a recording medium suitably used in an inkjet recording method, and a method of manufacturing the same.

2. Description of the Related Art

In recent years, a variety of information processing systems have been developed together with rapid advancements in the information technology industry, and recording methods and recording instruments suitable for these information processing systems have also been developed and put into practical use. Among these, an inkjet recording method has seen widespread business and personal use, in view of advantages such as a capability of recording on a variety of recording materials, relatively inexpensive and compact hardware (apparatus), and excellent quietness.

With an increase in the resolution of inkjet printers and improvements in the hardware (apparatus) in recent years, a variety of media for inkjet recording have also been developed. Accordingly, it has become possible to obtain high quality recorded materials, including photo-like recorded materials.

Characteristics that are particularly required for a recording medium for inkjet recording include, in general, (1) quick-drying properties (a high degree of ink absorption rate); (2) an adequate and uniform ink dot diameter (generating no bleeding); (3) favorable graininess; (4) a high degree of circularity of dots; (5) a high degree of color density; (6) a high degree of color saturation (being dullness-free); (7) excellent light resistance, gas resistance, and water resistance of a printing area; (8) a high degree of whiteness of a recording surface; (9) favorable storability of a recorded medium (no yellowing or discoloration even during long periods of storage, and no image bleeding even during long periods of storage; (10) dimensional stability with favorable resistance to deformation (having a sufficiently small amount of curling); and (11) favorable traveling performance in hardware. Moreover, in applications of photographic glossy paper used for obtaining a photo-like high-quality recorded product, there are further requirements such as glossiness, surface smoothness, and a photographic paper-like texture similar to that obtained in silver salt photography.

As a recording medium that can achieve both of high surface glossiness and high image density, an inkjet recording medium having, on a support, a first ink-receiving layer containing fumed silica and a second ink-receiving layer containing pseudo-boehmite alumina formed on the first inkjet recording layer has been known (see, for example, Japanese Patent Application Laid-Open (JP-A) Nos. 2002-225423 and 2004-203010).

Further, an inkjet recording medium having, on a support, a first ink-receiving layer containing fumed silica dispersed by a cationic polymer and a second ink-receiving layer containing fumed silica dispersed by a water-soluble polyvalent metal compound formed on the first ink-receiving layer has also been known (see, for example, JP-A No. 2007-118346).

However, the inkjet recording media disclosed in JP-A Nos. 2002-225423 and 2004-203010 have a problem that when the ink receiving layer containing pseudo-boehmite alumina is provided over the ink receiving layer containing dispersed fumed silica, coating defects tend to occur in the ink receiving layer containing pseudo-boehmite alumina. Further, the inkjet recording medium disclosed in JP-A No. 2007-118346 does not have a sufficient printing density.

### SUMMARY OF THE INVENTION

In view of the above-mentioned problems, an aspect of the present invention provides an inkjet recording medium, comprising at least a first ink-receiving layer and a second ink-receiving layer on a support, the first ink-receiving layer being positioned farthest from the support and containing pseudo-boehmite alumina, and the second ink-receiving layer being positioned between the first ink receiving layer and the support and containing a water-soluble polyvalent metal salt and fumed silica that is dispersed using the water-soluble polyvalent metal salt.

A second aspect of the present invention provides a method of manufacturing an inkjet recording medium comprising forming a coating layer on a support by applying a coating composition for forming a first ink-receiving layer containing pseudo-boehmite alumina and a coating composition for forming a second ink-receiving layer containing fumed silica that is dispersed using a water-soluble polyvalent metal compound, the coating composition for forming the first ink-receiving layer and the coating composition for forming the second ink-receiving layer being applied silmultaneously such that the coating composition for forming the first ink-receiving layer is applied over the coating composition for forming the second ink-receiving layer.

### DETAILED DESCRIPTION OF THE INVENTION

The present invention provides an inkjet recording medium including a support and at least two ink-receiving layers formed on the support. The ink-receiving layers include a first ink-receiving layer positioned farthest from the support, and a second ink-receiving layer positioned between the first ink-receiving layer and the support. The first ink-receiving layer contains at least one kind of pseudo-boehmite alumina, and the second ink-receiving layer contains at least one kind of water-soluble polyvalent metal salt and at least one kind of fumed silica that is dispersed using the water-soluble polyvalent metal salt.

By including fumed silica dispersed using the water-soluble polyvalent metal compound in the second ink-receiving layer, generation of coating defects in the first ink-receiving layer containing pseudo-boehmite alumina, which is formed on the second ink receiving layer, can be suppressed. As a result, a high degree of glossiness and a high degree of printing density can be realized.

The support used in the present invention is preferably a water-resistant support. Examples of the water-resistant support usable in the invention include a film made of polyethylene, polypropylene, polyvinylchloride, diacetate resin, triacetate resin, cellophane, acrylic resin, polyethylene telephthalate, polyethylenenaphthalate, or the like, and resin coated paper. In particular, the thickness of the support is preferably from about 50 μm to about 250 μm.

When a coating liquid for forming an ink receiving layer is applied onto the aforementioned film or resin coated paper, the surface thereof may be subjected to corona discharge treatment, flame treatment, ultraviolet ray irradiation treatment, plasma treatment, or the like, prior to the application of the coating liuqid.

When the aforementioned film or resin coated paper is used for the support in the present invention, it is preferable to provide a primer layer mainly composed of a natural polymer compound or a synthetic resin on the surface of the support over which the ink receiving layer is to be disposed.

The primer layer provided on the support may include, as a main component, a natural polymer compound such as gelatin, casein or the like, or a synthetic resin. Examples of the synthetic resin include an acrylic resin, a polyester resin, a vinylidene chloride resin, a vinyl chloride resin, a vinyl acetate resin, polystyrene, a polyamide resin, and a polyurethane resin.

The primer layer may be provided on the support to a thickness of from 0.01 to 5 μm (dry film thickness). The dry film thickness of the primer layer is preferably within the range of from 0.05 to 5 μm.

A backcoat layer of various kinds may be provided on the support for the purpose of endowing a writing ability, an antistatic property, transportability, an anti-curling property, or the like. One or more agents selected from an inorganic antistatic agent, an organic antistatic agent, a hydrophilic binder, a latex, a pigment, a hardener, a surfactant, and the like, may be appropriately included in the backcoat layer.

The first ink-receiving layer in the present invention contains at least one kind of pseudo-boehmite alumina. By including pseudo-boehmite alumina in the first ink-receiving layer, transparency of the layer can be improved, an image with high density can be recorded, and a high glossiness can be attained. Futher, ink absorbency and the absorption rate thereof can be improved.

The first ink-receiving layer in the present invention contains pseudo-boehmite alumina, but may also contain fine inorganic particles other than pseudo-boehmite alumina, as long as the effect of the invention is not obstructed. Although the kind of the fine inorganic particles is not particularly limited, it is preferably fumed silica, fumed alumina, or the like, from the viewpoint of ink absorbency. The inorganic particles may be used alone, or in combination of two or more kinds.

The pseudo-boehmite alumina used in the present invention may be expressed by the following formula: Al₂O₃.nH₂O (1<n<3), namely, an alumina hydrate when n exceeds 1 but is less than 3 in the above formula. The alumina hydrate can be obtained by known methods including hydrolysis of an aluminum alkoxide such as aluminum isopropoxide, neutralization of an aluminum salt using an alkali, and hydrolysis of an aluminate.

The pseudo-boehmite alumina used in the present invention is preferably those prepared by crashing secondary particle crystals of the pseudo-boehmite alumina having a diameter of from several thousand nm to several tens of thousand nm by means of ultrasonic waves, a high-pressure homogenizer or a collision-type jet pulverizer to a diameter of from about 50 to 300 nm.

In the present invention, the average particle diameter of the primary particles of the pseudo-boehmite alumina is preferably from 5 to 30 nm. By making the average particle diameter of the primary particles of the pseudo-boehmite alumina to less than 30 nm, glossiness of the surface and transparency of the ink receiving layer can be improved, and the print density can be increased. Further, by making the average particle diameter of the primary particles of the pseudo-boehmite alumina to 5 nm or more, ink absorbency can be improved.

The average particle diameter of the primary particles of the pseudo-boehmite alumina in the present invention is obtained as an average diameter of circles each equivalent to a projected area of 100 particles existing in a predetermined area, which can be measured by observing the dispersed particles by an electron microscope. The average particle diameter of spindle-shaped particles is obtained as an average value of a major axis and a minor axis thereof.

For dispersing pseudo-boehmite alumina in the present invention, an acid such as a lactic acid, an acetic acid, a formic acid, a nitric acid, a hydrochloric acid, a hydrobromic acid, an aluminum chloride, or the like, may be used. The addition amount of the acid is generally from 0.1 to 5% by mass, with respect to the total amount of pseudo-boehmite alumina. By using pseudo-boehmite alumina dispersed using an acid, favorable characteristics of a coating liquid and a favorable coating ability thereof can be obtained even when boric acid or a borate is used. As a result, glossiness in a blank area and ink absorbency can be improved.

In the present invention, the total amount of pseudo-boehmite alumina contained in the first ink-receiving layer is, for example, in the range of from 3 to 35 g/m², preferably from 5 to 20 g/m². When the total amount of pseudo-boehmite alumina is 5 g/m² or more, the surface glossiness of the inkjet recording medium can be improved more effectively. Further, when the total amount of pseudo-boehmite alumina is 20 g/m² or less, a favorable level of ink absorbency can be achieved. In the present invention, only a single kind of pseudo-boehmite alumina may be used, or two or more kinds thereof may be used in combination.

The second ink-receiving layer in the present invention contains at least one kind of water-soluble polyvalent metal salt and at least one kind of fumed silica dispersed by the water-soluble polyvalent metal salt. It is preferable that the amount of the water-soluble polyvalent metal salt with respect to the fumed silica contained in the second ink-receiving layer is from 3 to 30% by mass, more preferably from 5 to 20% by mass. By using the water-soluble polyvalent metal salt in an amount of 3% by mass or more, the fumed silica can be dispersed in a more favorable manner. Further, by using the water-soluble polyvalent metal salt in an amount of 30% by mass or less, printing density and image storability (having suppressed bleeding under high humidity) can be further enhanced.

The second ink-receiving layer in the present invention contains fumed silica, but may also contain fine inorganic particles other than fumed silica as long as the effect of the invention is not obstructed. Although the kind of the fine inorganic particles is not particularly limited, it is preferably fine particles of silica other than fumed silica, alumina, or the like, from the viewpoints of glossiness and ink absorbency. Only a single kind of inorganic particles may be used, or two or more kinds thereof may be used in combination.

The fumed silica used in the present invention is prepared by a method called a dry process, in contrast to a wet process, which is usually a flame hydrolysis process. Specifically, a method in which silicon tetrachloride is burned together with hydrogen and oxygen is generally known. Silanes such as methyltrichlorosilane or trichlorosilane may also be used instead of silicon tetrachloride, or in combination with silicon tetrachloride. Fumed silica is available as AEROSIL (trade name) from Japan Aerosil Co., Ltd, QS TYPE (trade name) from TOKUYAMA Corporation, and the like.

Generally, famed silica is in the form of secondary particles formed from primary particles of fumed silica aggregating with a moderate amount of voids. In view of favorable glossiness and ink absorbency, the fumed silica used in the present invention is preferably in the form of secondary particles having a diameter of 500 nm or less, more preferably from 100 to 400 nm, which can be prepared by crashing amd dispersing primary particles of fumed silica having an average diameter of from 3 to 50 nm using ultrasonic waves, a high-pressure homogenizer, or a collision-type jet pulverizer, until they form secondary particles having a diameter of the above range.

The average particle diameter of the secondary particles of fumed silica is obtained by conducting a measurement using a thin dispersion of fumed silica with a laser diffraction/scattering-type particle size distribution measuring equipment. The average particle diameter of primary particles of fumed silica can be measured in a similar manner to the aforementioned pseudo-boehmite alumina.

The average particle diameter of primary particles of fumed silica used in the invention is preferably from 3 to 50 nm. By making the average particle diameter of the primary particles of fumed silica to 50 nm or less, glossiness can be improved in a more effective manner. In addition, the ink absorption rate of the second ink-receiving layer can be adjusted to an appropriate degree, fixing of a colorant or an adhesive contained in the ink to the first ink-receiving layer formed on the second ink-receiving layer can be promoted, and a scratch resistance in an printed area can be improved. Further, glossiness of the printed area can be improved and vivid colors with high print density can be obtained.

On the other hand, by making the average particle diameter of the primary particles of fumed silica to 3 nm or more, the amount of the ink remaining in the first ink-receiving layer can be suppressed to an appropriate degree, occurrence of bleeding or beading can be suppressed in a more effective manner, and occurrence of stains on the back surface of the inkjet recording medium can be suppressed, even when printing is performed in a consecutive manner.

Examples of the water-soluble polyvalent metal salt used in the present invention include a water-soluble salt of a metal such as calcium, barium, manganese, copper, cobalt, nickel, aluminum, iron, zinc, zirconium, chromium, magnesium, tungsten and molybdenum. Specific examples thereof include calcium acetate, calcium chloride, calcium formate, calcium sulfate, barium acetate, barium sulfate, barium phosphate, manganese chloride, manganese acetate, manganese formate dihydrate, manganese sulphate ammonium hexahydrate, cupric chloride, ammonium chloride copper (II) dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, nickel amidosulfate tetrahydrate, aluminum sulfate, aluminum sulfite, aluminium thiosulfate, poly aluminum chloride, aluminum nitrate nonahydrate, aluminum chloride hexahydrate, aluminum lactate, ferrous bromide, ferrous chloride, ferric chloride, ferrous sulfate, ferric sulfate, zinc phenolsulfate, zinc bromide, zinc chloride, zinc nitrate hexahydrate, zinc sulfate, zirconium acetate, zirconium chloride, zirconium oxychloride octahydrate, zirconium hydroxychloride, zirconyl acetate, zirconyl nitrate, zirconyl octate, zirconyl hydroxychloride, chromium acetate, chromium sulfate, magnesium sulfate, magnesium chloride hexahydrate, magnesium citrate nonahydrate, sodium phosphotungstate, sodium citrate tungsten, dodecatungstophosphoric acid n-hydrate, dodecatungstosilicic acid 26-hydrate, molybdenum chloride, and dodecamolybdophosphoric acid n-hydrate. Among these, in particular, water-soluble salts of aluminum and elements in the IVa group in the periodic table (such as zirconium and titanium) are preferable.

In the invention, the term “water-soluble” means that the polyvalent metal salt can dissolve in water in a concentration of 1% by mass or more under ordinary temperature and pressure.

Basic aluminum polyhydroxides may also be preferably used as the water-soluble aluminum compound. The basic aluminum polyhydroxides are water-soluble aluminum polyhydroxides including, as a major component, a basic high-molecular polynuclear condensation ion represented by the following Formula 1, 2 or 3, such as [Al₆(OH)₁₅J³⁺, [Al₁₈(OH)₂₀]⁴⁺, [Al₁₃(OH)₃₄]⁵⁺, and [Al₂₁(OH)₆₀]³⁺.

| | |
|---|---|
| [Al₂(OH)ₙCl₍₆₋ₙ₎]ₘ | Formula 1 |
| [Al(OH)₃]ₙAlCl₃ | Formula 2 |
| Alₙ(OH)ₘCl₍₃ₙ₋₋ₘ₎ (0 < m < 3n) | Formula 3 |

These compounds are supplied from Taki Chemical Co., Ltd. under the name of aluminum polychloride (PAC) as a water treatment agent; from Asada Chemical Industry Co., Ltd. under the name of aluminum polyhydroxide (Paho); from Riken Green Co., Ltd. under the name of PURACHEM WT; and from other manufacturers for similar purposes. Products of various grades are easily available. In the present invention, those commercially available products may be used without modification, but when a pH value thereof is too low, treatment to adjust the pH may be conducted as appropriate.

In the present invention, the content of the water-soluble polyvalent metal salt in the ink receiving layer is preferably from 0.1 g/m² to 10 g/m², and more preferably from 0.2 g/m² to 5 g/m². The water-soluble polyvalent metal salt may be used alone, or in combination of two or more kinds.

From the viewpoint of effectively suppressing the occurrence of coating defects, the fumed silica used in the invention is preferably prepared by a high-pressure dispersing treatment with the use of a water-soluble salt compound of aluminum or zirconium in an amount of from 3 to 30% by mass with respect to the amount of the fiumed silica, as the water-soluble polyvalent metal salt. The water-soluble polyvalent metal salt is more preferably at least one selected from basic poly aluminum hydroxide compounds, aluminum lactate, zirconyl acetate, zirconyl hydroxychloride, zirconyl nitrate, zirconyl octate and zirconium oxychloride, in an amount of from 5 to 20% by mass with respect to the amount of the fumed silica.

In the present invention, an organic cation polymer may be used in the process of dispersing fumed silica, in addition to the water-soluble polyvalent metal salt, from the viewpoint of facilitating the addition of the fumed silica. The organic cation polymer used in the present invention is not particularly restricted, but is preferably an organic cation polymer having an I/O value of 2.2 or greater, more preferably 2.5 or greater.

The I/O value is defined as a value obtained by dividing an inorganic value with an organic value based on an organic conceptual diagram. The I/O value can be obtained in accordance with a method described in “Organic Conceptual Diagram—Basic and Application—” (written by Kouda Yoshio, published by Sankyo Publishing, 1984).

In the organic conceptual diagram, properties of an organic compound is represented by an organic value, expressing a covalent bonding property, and an inorganic value, expressing an ion bonding property, and all kinds of the organic compounds are given a position in the diagram at which an axis expressing the organic value and an axis expressing an inorganic value cross each other. The inorganic value based on the above concept represents an inorganic property, namely, a degree of influence on a boiling point of various substituents which is determined based on a hydroxyl group. Since the distance between a boiling point curve of a linear alcohol and a boiling point curve of a linear paraffin in the vicinity of the carbon number of 5 is about 100° C., the influence of one hydroxyl group is determined as a numerical value of 100. On the other hand, the organic value represents an organic property, and the numerical value thereof is determined by the number of carbon atoms representing a methylene group included in the molecule as a unit. The numerical value of one carbon atom as a basic value is determined as 20 from an average value of 20° C., which is an amount of increase in a boiling point of a linear compound in the vicinity of the carbon number of 5 to 10, caused by adding one carbon atom. The inorganic value and the organic value of each compound are determined so as to correspond to each other, in a one-to-one manner in the diagram. The I/O value is calculated from these values.

In the present invention, it is preferable that the fumed silica used in the second ink-receiving layer is dispersed using an organic cationic polymer having an I/O value of 2.2 or more in an amount of 20% by mass or less with respect to the amount of the water-soluble polyvalent metal salt, more preferably in an amount of from 3 to 15% by mass with respect to the amount of the water-soluble polyvalent metal salt.

When the I/O value of the organic cationic polymer is 2.2 or more, addition of the fumed silica in a dispersion process can be performed more smoothly, and occurrence of coating defects can be suppressed. When the content of the organic cationic polymer is 15% by mass or less with respect to the amount of the water-soluble polyvalent metal salt, aggregation of the pseudo-boehmite alumina and the fumed silica can be suppressed, and as a result, occurrence of coating defects can be suppressed in a more effective manner.

Specific examples of the organic cationic polymer used in the invention include polyethyleneimine, polydiallylamine, polyallylamine, and polymers having a primary to tertiary amino group or a quaternary ammonium base disclosed in JP-A Nos. 59-20696, 59-33176, 59-33177, 59-155088, 60-11389, 60-49990, 60-83882, 60-109894, 62-198493, 63-49478, 63-115780, 63-280681, 1-40371, 6-234268, 7-125411 and 10-193776. The molecular weight of those organic cationic polymers is preferably from about 5,000 to about 100,000.

The first ink-receiving layer in the present invention and the second ink-receiving layer may contain a water-soluble binder. Examples of the water-soluble binder include polyvinyl alcohol (PVA), starch and modified products thereof, gelatin and modified products thereof, natural polymer resins such as casein, pullulan, gum arabic, karaya gum, albumin, and derivatives thereof; modified polyvinyl alcohol such as cation-modified polyvinyl alcohol and silanol-modified polyvinyl alcohol; latexes such as SBR latex, NBR latex, methyl methacrylate-butadiene copolymers, and ethylene-vinyl acetate copolymers; vinyl polymers such as polyacrylamide and polyvinylpyrrolidone; polyethyleneimine, polypropylene glycol, polyethylene glycol, maleic anhydride and copolymers thereof. However, the present invention is not limited thereto.

Among these, polyvinyl alcohol (PVA) is preferable, and polyvinyl alcohol having an average polymerization degree of 3,000 or more and a saponification degree of from 75 to 90% is particularly preferable from the viewpoints of improvements in miscibility with pseudo-boehmite alumina or fumed silica, viscosity of the coating composition, film-forming properties and printing density. When the average polymerization degree is 3,000 or more, strength of the coating can be enhanced and cracks can be prevented, and an increase in a haze value after printing can be suppressed, thereby promoting an increase in printing density.

In addition, when the saponification degree is 75% or more, strength of the coating can be elevated and formation of cracks can be suppressed. When the saponification degree is 90% or less, reaction between pseudo-boehmite alumina and fumed silica can be suppressed and gelation of the coating composition can be suppressed, and an increase in a haze value in the image receiving layer after printing can be suppressed, thereby promoting increase in printing density.

The saponification degree of PVA can be measured from the amount of consumption of sodium hydroxide after reacting residual acetic acid groups in the PVA with a predetermined amount of sodium hydroxide. The average polymerization degree of PVA is preferably from 3,000 to 5,000 from the viewpoints of increasing printing density and film strength. The molecular weight can be calculated from a product obtained by multiplying a formula weight of the monomer with the average polymerization degree.

The water-soluble binder may be used alone, or in combination of two or more kinds thereof. For example, polyvinyl alcohol and one or more water-soluble binders other than polyvinyl alcohol may be used in combination.

In the present invention, the total content ratio of the water-soluble binder (for example, PVA or a combination of PVA and other water-soluble binder(s)) in the first ink-receiving layer is preferably from 5 to 20% by mass, more preferably from 8 to 15% by mass, with respect to the amount of the pseudo-boehmite alumina. In addition, the total content ratio of the water-soluble binder (for example, PVA or a combination of PVA and other water-soluble binder(s)) in the second ink-receiving layer is preferably from 5 to 20% by mass, more preferably from 8 to 15% by mass, with respect to the amount of the fumed silica.

When the amount of the water-soluble binder is within the above range, film formation upon application of a coating composition can be readily performed, occurrence of cracks and falling of powder in the coating can be avoided, and favorable ink absorbency can be obtained.

In the first ink-receiving layer of the present invention, it is preferable that PVA is used as a water-soluble binder, and that a mass ratio between pseudo-boehmite alumina (Al) and polyvinyl alcohol (PVA) satisfies the relation of Al/PVA>8. When the mass ratio (Al/PVA) satisfies the above range, a degree of haze can be suppressed, and both of image density and glossiness can be achieved at high levels. The mass ratio (Al/PVA) is more preferably within the range of from 8 to 15 from the viewpoints of suppressing the haze value, maintaining the miscibility with alumina hydrate, adjusting the viscosity of the coating composition, and maintaining the film forming property, while achieving image density and glossiness at high levels.

In the second ink-receiving layer of the present invention, it is preferable that PVA is used as a water-soluble binder, and a mass ratio between fumed silica (Si) and polyvinyl alcohol (PVA) satisfies the relation of Si/PVA>2. When the mass ratio (Si/PVA) satisfies the above relation, the degree of haze can be suppressed, and both of image density and glossiness can be achieved at high levels. The mass ratio (Si/PVA) is more preferably within the range of from 3 to 6, from the viewpoints of suppressing the haze value, maintaining the miscibility with alumina hydrate, adjusting the viscosity of the coating composition, and maintaining the film forming property, while achieving image density and glossiness at high levels.

Each of the ink receiving layers in the present invention may contain oil droplets of various kinds in order to improve the brittleness of the coating film. Examples of the oil droplets include those of a hydrophobic high-boiling-point organic solvent having a solubility in water of 0.01% by mass or less at room temperature (for example, liquid paraffin, dioctyl phthalate, tricresylphosphate and silicone oil) and polymer particles (for example, particles formed by polymerizing one or more polymerizable monomers such as styrene, butylacrylate, divinylbenzene, butylmethacrylate and hydroxyethyl methacrylate). The oil droplets are preferably used in an amount of from 10 to 50% by mass with respect to the amount of the water-soluble binder.

In the present invention, each of the ink receiving layers may contain a crosslinking agent for the purpose of improving water resistance and dot reproducibility. The crosslinking agent may be suitably selected in view of the type of the water-soluble binder contained in the ink receiving layer.

When polyvinyl alcohol is used as the water-soluble binder, boric acid and/or a borate is preferably used as the crosslinking agent in view of a rapid reaction speed. For example, orthoboric acid, metaboric acid, or hypoboric acid can be used as the boric acid, and soluble salts of these boric acids are preferable as the borate. Specific examples of the borates include Na₂B₄O₇.10H₂O, NaBO₂.4H₂O, K₂B₄O₇.5H₂O, NH₄HB₄O₇.3H₂O and NH₄BO₂. However, the present invention is not limited thereto.

When gelatin is used as the water-soluble binder, compounds other than boric acid and a salt thereof can be used as the crosslinking agent. Examples of these crosslinking agents include aldehyde compounds such as formaldehyde, glyoxal and glutaraldehyde; ketone compounds such as diacetyl and cyclopentanedione; active halogen compounds such as bis(2-chloroethylurea)-2-hydroxy-4,6-dichloro-1,3,5-triazine, 2,4-dichloro-6-S-triazine sodium salt; active vinyl compounds such as divinyl sulfonic acid, 1,3-divinylsulfonyl-2-propanol, N,N′-ethylenebis(vinylsulfonylacetamide), and 1,3,5-triaclyroyl-hexahydro-S-triazine; N-methylol compounds such as dimethylol urea and methylol dimethylhydantoin; melamine resins (for example, methylolmelamine, alkylated methylolmelamine; epoxy resins; isocyanate compounds such as 1,6-hexamethylene diisocyanate; aziridine compounds described in U.S. Pat. Nos. 3,017,280 and 2,983,611; carboxyimide compounds described in U.S. Pat. No. 3,100,704; epoxy compounds such as glycerol triglycidyl ether; ethylene imino compounds such as 1,6-hexamethylene-N,N′-bisethylene urea; halogenated carboxyaldehyde compounds such as mucochloric acid and mucophenoxy chloric acid; dioxane compounds such as 2,3-dihydroxydioxane, metal-containing compounds such as titanium lactate, aluminum sulfate, chromium alum, potassium alum, zirconium acetate and chromium acetate; polyamine compounds such as tetraethylenepentamine; hydrazide compounds such as dihydrazine adipate; and low molecular weight compounds or polymers containing at least two oxazoline groups. The crosslinking agent may be used alone, or in combination of two or more kinds.

The crosslinking agent may also be contained in a coating composition for forming a layer adjacent to the ink receiving layer, as with in a coating composition for forming an ink receiving layer (coating composition for an ink receiving layer). Alternatively, a coating composition containing a crosslinking agent may be applied onto a support prior to applying the coating composition for forming an ink receiving layer; or a coating composition containing a crosslinking agent may be applied after applying the coating composition for forming the ink receiving layer and drying the formed ink receiving layer.

The crosslinking agent (preferably boric acid and/or a salt thereof) may be used alone, or in combination of two or more kinds. The total content of the crosslinking agent in the coating composition is preferably from 5 to 40 parts by mass, more preferably 15 to 35 parts by mass, with respect to 100 parts by mass of the water-soluble binder. When the amount of the crosslinking agent is within the above range, the water-soluble agent can be effectively crosslinked and formation of cracks or the like can be suppressed.

In the present invention, each ink receiving layer may contain, in addition to the surfactant or the crosslinking agent, known additives such as a coloring dye, a coloring pigment, a stabilizer for an ink dye, a UV absorber, an antioxidant, a dispersing agent for a pigment, a defoaming agent, a leveling agent, a preservative, a fluorescent brightener, a viscosity stabilizer, or a pH regulating agent.

In the present invention, one or more additional layers other than the first ink-receiving layer and the second ink-receiving layer may be provided. When an additional layer is provided, it is necessary that the additional layer does not substantially obstruct the ink permeability, and it is preferable that the uppermost layer located farthest from the support is the first ink-receiving layer containing pseudo-boehmite alumina, from a viewpoint of glossiness.

In the present invention, the ink receiving layer can be formed by applying a coating composition for forming the ink receiving layer onto the support, or onto an ink receiving layer that has been formed on the support. Known application methods may be used for the application of each of the ink receiving layers. Examples of the methods include a slide bead method, a curtain method, an extrusion method, an air knife method, a roller coating method, and a rodbar coating method.

In the present invention, the coating composition for forming the ink receiving layer can be prepared by mixing a dispersion of pseudo-boehmite alumina or fumed silica with a water-soluble binder, a crosslinking agent, or various kinds of additives as occasion demands, in an ordinary manner.

The solvent used for preparing the coating composition for forming the ink receiving layer may be water, an organic solvent, or a mixture thereof. Examples of the organic solvent that can be used include alcohols such as methanol, ethanol, n-propanol, i-propanol, methoxy propanol or the like, ketones such as acetone, methylethyl ketone or the like, tetrahydrofuran, acetonitrile, ethyl acetate, and toluene.

In the present invention, the pH of the coating composition for forming the ink receiving layer may be appropriately selected depending on stability, viscosity, and ink fixability of the coating composition. The pH is preferably from 4 to 7 in the coating composition for forming the first ink receiving layer containing pseudo-boehmite alumina, and is preferably from 3 to 6 in the coating composition for forming the second ink-receiving layer containing fumed silica. When the pH values are within the above ranges, favorable ink absorbency and ink fixability can be achieved.

The method of manufacturing the inkjet recording medium of the present invention includes at least a coating process in which a coating composition for forming a first ink-receiving layer containing pseudo-boehmite alumina and a coating composition for forming a second ink-receiving layer containing fumed silica dispersed by a water-soluble polyvalent metal salt are simultaneously applied over a support such that the coating composition for forming the first ink-receiving layer is applied over the coating composition for forming the second ink-receiving layer.

When the first ink-receiving layer containing pseudo-boehmite alumina is formed simultaneously with the second ink-receiving layer containing fumed silica, there is a tendency that coating defects are formed in the first ink receiving layer. On the other hand, in the method of manufacturing the inkjet recording medium of the present invention, the fumed silica contained in the second ink-receiving layer, positioned under the first ink-receiving layer, is dispersed by using the water-soluble polyvalent metal salt. Accordingly, the influence of the coating composition for forming the second ink receiving layer on the pseudo-boehmite alumina contained in the coating composition for forming the first ink-receiving layer can be alleviated, compared to the case with the conventional simultaneous multi-layer application method. As a result, generation of coating defects in the first ink-receiving layer can be effectively suppressed.

By forming the ink receiving layers simultaneously without providing a process of drying each layer, properties required for each layer can be efficiently obtained, and favorable effects on production efficiency can also be achieved. The reason for the above is thought to be that by laminating the layers in a wet state, permeation of components of an overlying layer into an underlying layer can be suppressed, thereby maintaining composition of the components of each layer in a favorable state.

The simultaneous multi-layer application method can be carried out using a known coater, such as a slide bead coater, a curtain flow coater, and an extrusion die coater.

In the present invention, the coating amount of the coating composition for forming the ink receiving layer containing pseudo-boehmite alumina is preferably from 3 to 50 g/m² in solid content conversion, and is more preferably from 20 to 45 g/m² in solid content conversion. The coating amount of the coating composition for forming the ink receiving layer containing fumed silica is preferably from 3 to 50 g/m² in solid content conversion, and is more preferably from 20 to 45 g/m² in solid content conversion. When the coating amounts are within the above ranges, favorable drying properties of the coating film can be achieved and formation of cracks can be avoided.

In the method of manufacturing the inkjet recording medium of the present invention, the ink receiving layer is preferably dried in a condition including a stage at which the film surface temperature of the coating film becomes less than 20° C. Specifically, the drying process includes a drying stage at which the film surface temperature becomes less than 20° C., which stage may be provided at an early stage of the drying, after a lapse of a predetermined time period from the initiation of the drying, or at a later stage of the drying. However, the stage at which the film surface temperature becomes less than 20° C. preferably occurs in the drying process at an early stage of the drying, particularly preferably immediately after the initiation of the drying, from the viewpoints of formation of a uniform coating surface condition and a void capacity. By carrying out the drying process in such a manner that the film surface temperature becomes less than 20° C. at an early stage of the drying (particularly preferably immediately after the initiation of the drying), unevenness in drying can be avoided even when the viscosity of the coating composition is low, and the surface glossiness can be enhanced. When the drying is carried out at high temperature at an early stage of the drying, unevenness in drying may occur and glossiness may decrease, particularly when the viscosity of the coating composition is low, or the like.

By providing a stage at which the film surface temperature becomes less than 20° C. in the drying process, viscosity of the film surface of the coating composition can be rapidly increased and a more uniform coating surface can be obtained. The above film surface temperature is preferably 0° C. or more but less than 20° C., more preferably from 5° C. to 15° C. When the film surface temperature is 0° C. or more, too much increase in the viscosity of the coating composition can be suppressed and formation of irregularities in the surface of the coating film can be prevented, thereby realizing high glossiness.

The film surface temperature as defined above is the temperature of the surface of the coating film in a dried state, which can be measured by a radiation thermometer.

Although depending on the degree of the heat resistance of the support, the drying temperature is preferably from 60 to 200° C., more preferably from 70 to 150° C. When the drying temperature is within the above range, ink absorbency can be further improved, and the water resistance of the ink receiving layer can also be improved.

The following are exemplary embodiments provided by the present invetnion.

1. An inkjet recording medium, comprising at least a first ink-receiving layer and a second ink-receiving layer on a support, the first ink-receiving layer being positioned farthest from the support and containing pseudo-boehmite alumina, and the second ink-receiving layer being positioned between the first ink receiving layer and the support and containing a water-soluble polyvalent metal salt and fumed silica that is dispersed using the water-soluble polyvalent metal salt.

2. The inkjet recording medium according to 1, wherein the fumed silica is dispersed using the water-soluble polyvalent metal salt in an amount of from 3 to 30% by mass with respect to the amount of the fumed silica.

3. The inkjet recording medium according to 1, wherein the fumed silica is dispersed using the water-soluble polyvalent metal salt and an organic cationic polymer having an I/O value of 2.2 or more in an amount of 20% by mass or less with respect to the amount of the water-soluble polyvalent metal salt.

4. The inkjet recording medium according to 2, wherein the fumed silica is dispersed using the water-soluble polyvalent metal salt and an organic cationic polymer having an I/O value of 2.2 or more in an amount of 20% by mass or less with respect to the amount of the water-soluble polyvalent metal salt.

5. The inkjet recording medium according to 1, wherein an average diameter of primary particles of the fumed silica is from 3 to 50 nm.

6. The inkjet recording medium according to 1, wherein the water-soluble polyvalent metal salt is a water-soluble metal salt of aluminum or an element in the IVa group in the periodic table.

7. The inkjet recording medium according to 6, wherein the water-soluble polyvalent metal salt is a basic poly aluminum hydroxide compound.

8. The inkjet recording medium according to 1, wherein at least one of the first ink-receiving layer and the second ink-receiving layer contains a water-soluble binder.

9. The inkjet recording medium according to 1, wherein at least one of the first ink-receiving layer and the second ink-receiving layer contains a crosslinking agent.

10. A method of manufacturing an inkjet recording medium comprising forming a coating layer on a support by applying a coating composition for forming a first ink-receiving layer containing pseudo-boehmite alumina and a coating composition for forming a second ink-receiving layer containing fumed silica that is dispersed using a water-soluble polyvalent metal compound, the coating composition for forming the first ink-receiving layer and the coating composition for forming the second ink-receiving layer being applied silmultaneously such that the coating composition for forming the first ink-receiving layer is applied over the coating composition for forming the second ink-receiving layer.

11. The method of manufacturing an inkjet recording medium according to 10, further comprising, after the application, drying the coating layer such that the drying comprises a stage at which the film surface temperature of the coating layer becomes less than 20° C.

12. The method of manufacturing an inkjet recording medium according to 11, wherein the stage at which the film surface temperature of the coating layer becomes less than 20° C. occurs immediately after the initiation of the drying.

13. The method of manufacturing an inkjet recording medium according to 10, wherein the drying is performed at a temperature of from 60 to 200° C.

14. The method of manufacturing an inkjet recording medium according to 10, wherein the fumed silica is dispersed using the water-soluble polyvalent metal salt in an amount of from 3 to 30% by mass with respect to the amount of the fumed silica.

15. The method of manufacturing an inkjet recording medium according to 10, wherein the fumed silica is dispersed using the water-soluble polyvalent metal salt and an organic cationic polymer having an I/O value of 2.2 or more in an amount of 20% by mass or less with respect to the amount of the water-soluble polyvalent metal salt.

16. The method of manufacturing an inkjet recording medium according to 10, wherein an average diameter of primary particles of the fumed silica is from 3 to 50 nm.

17. The method of manufacturing an inkjet recording medium according to 10, wherein the water-soluble polyvalent metal salt is a water-soluble metal salt of aluminum or an element in the IVa group in the periodic table.

18. The method of manufacturing an inkjet recording medium according to 17, wherein the water-soluble polyvalent metal salt is a basic poly aluminum hydroxide compound.

19. The method of manufacturing an inkjet recording medium according to 10, wherein at least one of the coating composition for forming the first ink-receiving layer or the coating composition for forming the second ink-receiving layer contains a water-soluble binder.

20. The method of manufacturing an inkjet recording medium according to 10, wherein at least one of the coating composition for forming the first ink-receiving layer and the coating composition for forming the second ink-receiving layer contains a crosslinking agent.

### EXAMPLES

In the following, the present invention will be explained in further details with reference to the examples. However, the examples should not be construed as limiting the present invention. In the examples, “part” and “%” mean “part by mass” and “% by mass”, respectively, unless otherwise mentioned.

### Example 1

Preparation of Pseudo-Boehmite Alumina Dispersion

To 2,042 g of ion-exchange water was added 708 g of pseudo-boehmite alumina (trade name: CATALOID AP-5, available from Catalysts & Chemicals Industries Co., Ltd, primary particle diameter: 8 nm) while stirring by a dissolver, thereby obtaining a crude dispersion of pseudo-boehmite alumina. The revolution rate of the dissolver at this time was 3,000 rpm and the revolution time was 10 minutes.

The crude dispersion of pseudo-boehmite alumina was subjected to fine dispersion using a high-pressure disperser (trade name: ULTIMIZER HJP25005, manufactured by SUGINO MACHINE LIMITED), thereby obtaining a white and transparent dispersion of pseudo-boehmite alumina with a solid content density of 25%. The pressure at this time was 100 MPa and the discharge rate was 600 g/min. The average particle diameter of the dispersion of pseudo-boehmite alumina was 0.06 μm.

Preparation of Fumed Silica Dispersion

To 3,300 g of ion-exchange water were added 100 g of basic poly aluminum chloride (trade name: ALFINE 83, available from Taimei Chemicals Co., Ltd.) as a water-soluble polyvalent metal salt and 600 g of fumed silica (trade name: AEROSIL 300, available from Japan Aerosil Co., Ltd, primary particle diameter: 7 nm) while stirring by a dissolver, thereby obtaining a crude dispersion of fumed silica. The revolution rate of the dissolver at this time was 3,000 rpm and the revolution time was 10 minutes.

The crude dispersion of fumed silica was subjected to fine dispersion using a high-pressure disperser (trade name: ULTIMIZER HJP25005 manufactured by SUGINO MACHINE LIMITED) to obtain a white and transparent dispersion of fumed silica with a solid content density of 15%. The pressure at this time was 100 MPa and the discharge rate was 600 g/min. The average particle diameter of the dispersion of fumed silica was 0.104 μm.

Preparation of Coating Composition for Forming Ink Receiving Layer

<Coating Composition for Forming an Upper Layer (First Ink-Receiving Layer)>

1012.5 g of the above-prepared dispersion of pseudo-boehmite alumina, 405 g of ion-exchange water, 97.1 g of a 7.5% boric acid aqueous solution, 346.7 g of a 7% aqueous solution of polyvinyl alcohol with a saponification degree of 88% and a polymerization degree of 4500 (trade name: PVA 245, available from KURARAY CO., LTD.), and 11.4 g of a 10% aqueous solution of a surfactant (trade name: SWANOLAM2150, available from Nikko Chemicals Co., Ltd.) were separately maintained at 60° C. and then mixed to obtain a coating composition for forming an ink receiving layer containing pseudo-boehmite alumina as a coating composition for forming an upper layer.

<Coating Composition for Forming a Lower Layer (Second Ink Receiving Layer)>

892.2 g of the above-prepared dispersion of fumed silica, 467.4 g of a 7% aqueous solution of polyvinyl alcohol with a saponification degree of 88% and a polymerization degree of 4500 (trade name: PVA 245, available from KURARAY CO., LTD.), 11.4 g of a 10% aqueous solution of a surfactant (trade name: SWANOLAM2150, available from Nikko Chemicals Co., Ltd.), 84.2 g of ion-exchange water, and 160 g of 59% industrial use ethanol (trade name: AP-7, available from Japan Alcohol Corporation) were separately maintained at 30° C. and then mixed at 30° C. to obtain a coating composition for forming an ink receiving layer containing flumed silica as a coating composition for forming a lower layer.

Preparation of Support

A mixture of broadleaf bleached kraft pulp (LBKP) and needleleaf bleached sulfite pulp (NBSP) with a mixing ratio of 1:1 was beaten to prepare a pulp slurry with a Canadian standard freeness of 300 ml. To the obtained pulp slurry were added 0.5% with respect to the pulp of alkylketenedimer as a sizing agent, 1.0% with respect to the pulp of polyacrylamide as a strengthening agent, 2.0% with respect to the pulp of cationized starch, and 0.5% with respect to the pulp of polyamide epichlorohydrin resin, and the resultant mixture was diluted with water to form a slurry with a concentration of 1%. The obtained slurry was subjected to papermaking with a fourdrinier machine to form a sheet with a weight of 170 g/m², and then subjecting the sheet to drying and humidifying to prepare base paper. A polyethylene resin composition prepared by uniformly dispersing 10% of anatase type titanium in 100% of low density polyethylene having a density of 0.918 g/cm³ was melted at 320° C., and the melted resin was applied onto one surface of the base paper to a thickness of 35 μm by extrusion coating at an extrusion rate of 200 m/min, which was further subjected to extrusion-coating using a cooling roller having a finely roughened surface. A blend resin composition prepared by blending 70 parts of high density polyethylene resin having a density of 0.962 g/cm³ and 30 parts of low density polyethylene resin having a density 0.918 g/cm³ was melted at 320° C. and extrusion-coated onto the other surface of the base paper to a thickness of 30 μm, which was further subjected to extrusion-coating using a cooling roller having a roughened surface. The polyolefin resin-coated paper was thus obtained.

The surface of the above-prepared polyolefin resin-coated paper was subjected to a high-frequency corona treatment, and a primer layer having the following composition was formed such that the amount of the gelatin was 50 mg/m², thereby obtaining a support.

—Composition of Primer Layer—

| | |
|---|---|
| Lime-treated gelatin | 100 parts |
| Sulfosuccinic acid-2-ethylhexyl ester salt | 2 parts |
| Chromium alum | 10 parts |

Preparation of Inkjet Recording Medium

Onto the above-prepared support with the primer layer formed thereon, the coating composition for forming an upper layer and the coating composition for forming a lower layer, which had been kept at 45° C. respectively, were applied simultaneously using a slide bead coater. The formed layers were cooled down for 30 seconds so that the film surface temperature became 12° C., and were then subjected to a drying process under the conditions of 45° C. and 10% RH until the total solid content density became 90% by mass, and subsequently under the conditions of 35° C. and 10% RH. An inkjet recording medium was thus prepared.

The coating amount of the coating composition for an upper layer was such that the application amount of the pseudo-boehmite alumina was 20 g/m², and the coating amount of the coating composition for a lower layer was such that the application amount of the fumed silica was 9 g/m², respectively.

### Examples 2 to 9

Inkjet recording media were prepared in a similar manner to Example 1, except that the dispersion of fumed silica was prepared using a water-soluble polyvalent metal salt, described in Table 1 below, instead of the basic poly aluminium chloride, respectively, such that the solid content mass thereof in each case was the same as that of Example 1.

### Example 10

An inkjet recording medium was prepared in a similar manner to Example 1, except that the dispersion of fumed silica was prepared by using 90 g of basic poly aluminum chloride and 7 g of diallyl dimethylammonium chloride homopolymer (trade name: SHALLOL DC902P, I/O value: 2.5, available from Dai-ichi Kogyo Seiyaku Co., Ltd), instead of 100 g of poly aluminum chloride.

### Example 11

An inkjet recording medium was prepared in a similar manner to Example 1, except that the dispersion of fumed silica was prepared using 400 g of basic poly aluminum chloride, instead of 100 g of basic poly aluminum chloride.

### Example 12

An inkjet recording medium was prepared in a similar manner to Example 1, except that the dispersion of fumed silica was prepared using 600 g of basic poly aluminum chloride, instead of 100 g of basic poly aluminum chloride.

### Example 13

An inkjet recording medium was prepared in a similar manner to Example 1, except that the dispersion of fumed silica was prepared using 90 g of basic poly aluminum chloride and 14 g of diallyl dimethylammonium chloride homopolymer (trade name: SHALLOL DC902PF I/O value: 2.5, available from Dai-ichi Kogyo Seiyaku Co., Ltd), instead of 100 g of basic poly aluminum chloride.

### Comparative Example 1

An inkjet recording medium was prepared in a similar manner to Example 1, except that the dispersion of fumed silica was prepared using 52.4 g of diallyl dimethylammonium chloride homopolymer (trade name: SHALLOL DC902P, I/O value: 2.5, available from Dai-ichi Kogyo Seiyaku Co., Ltd), instead of 100 g of basic poly aluminum chloride.

<Evaluation>

The following evaluations were conducted on each of the inkjet recording media obtained in the above-mentioned Examples and Comparative Example. The evaluation results are shown in Table 1.

(1) Printing Density

A black solid image was printed on each recording medium using an inkjet printer (trade name: “PM-A820”, manufactured by Seiko-Epson Corporation). The image density in the black area was measured with a reflection densitometer (trade name: GRETAG SPECTROLINO SPM-50) at a viewing angle of 2 degrees, using a light source “D50”, using no filter.

(2) Glossiness

The glossiness of each inkjet recording medium was measured by a digital variable angle glossmeter (trade name: UGV-5D, manufactured by SUGA TEST INSTRUMENTS CO., LTD, measuring hole: 8 mm) at an incident angle of 60 degrees and a photo-sensing angle of 60 degrees. The evaluation results are shown in Table 1.

(3) Coating defects

The occurrence of partial defects of 3 mm or greater and coating unevenness in the inkjet recording medium of about 100 m² were observed with naked eye, and were evaluated according to the following evaluation criteria.

Evaluation Criteria

A: Not more than one partial defect was observed.

B: 2 to 10 of partial defects were observed.

C: 11 to 100 of partial defects were observed.

D: 101 to 1000 of partial defects were observed.

E: 1001 or more of partial defects were observed.

TABLE 1-1

| | Dispersant for Fumed Silica | | | | | | |
|---|---|---|---|---|---|---|---|
| | | | | Concentration | | | |
| | | | | of dispersant | | | |
| | | | Solid content | (with respect to | Printing | | Coating |
| | Composition | Trade name | concentration | fumed silica) | density | Glossiness | defect |
| Example 1 | Al(OH)₅Cl | ALFINE83 | 23% | 3.8% | 2.98 | 48 | B |
| Example 2 | ZrO(C₂H₃O₂)₂ | ZIRCOZOL ZA30 | 30% | 3.8% | 2.98 | 45 | B |
| Example 3 | ZrO(OH)Cl•nH₂O | ZIRCOZOL ZC-2 | 35% | 3.8% | 3.10 | 50 | A |
| Example 4 | ZrO(NO₃)₂•nH₂O | ZIRCOZOL ZN | 18% | 3.8% | 2.93 | 45 | B |
| Example 5 | ZrO(C₈H₁₅O₂)₂ | ZIRCOZOL | 12% | 3.8% | 2.95 | 45 | B |
| | | OCTATE | | | | | |
| Example 6 | ZrOCl₂•8H₂O | ZIRCONIUM | 33% | 3.8% | 2.95 | 45 | B |
| | | OXYCHLORIDE | | | | | |
| Example 7 | Al(OH)(Lac acid)_{1.5}•nH₂O | TAKICERAM G-17P | 35% | 3.8% | 2.99 | 50 | A |
| Example 8 | Al(OH)(Lac acid)_{1.39}•nH₂O | TAKICERAM | 35% | 3.8% | 3.05 | 52 | A |
| | | M-160P | | | | | |
| Example 9 | Al(OH)(Lac acid)_{1.42}•nH₂O | TAKICERAM GM | 32% | 3.8% | 3.10 | 50 | A |
| Example 10 | Al(OH)₅Cl | ALFINE83 | 23% | 3.45% | 2.99 | 48 | B |
| | Diallyl | SHALLOL DC902P | 52% | 0.6% | | | |
| | dimethylammonium | | | | | | |
| | chloride | | | | | | |
| | homopolymer | | | | | | |
| Example 11 | Al(OH)₅Cl | ALFINE83 | 23% | 16% | 2.95 | 48 | A |
| Example 12 | Al(OH)₅Cl | ALFINE83 | 23% | 23.0% | 2.90 | 48 | A |
| Example 13 | Al(OH)₅Cl | ALFINE83 | 23% | 3.45% | 2.95 | 46 | B |
| | Diallyl | SHALLOL DC902P | 52% | 1.2% | | | |
| | dimethylammonium | | | | | | |
| | chloride | | | | | | |
| | homopolymer | | | | | | |
| Comparative | Diallyl | SHALLOL DC902P | 52% | 4.5% | 2.60 | 38 | E |
| Example 1 | dimethylammonium | | | | | | |
| | chloride | | | | | | |
| | homopolymer | | | | | | |

Note:
ALFINE83 is a product from Taimei Chemicals Co., Ltd.;
ZIRCOZOL ZA30, ZC-2 and ZN, ZICOZOL OCTATE and Ziconium oxychloride are products from Daiichi Kigenso Kagaku Kogyo Co., Ltd.;
TAKICERAM G-17P, M-160P and GM are products from Taki Chemical Co., Ltd.; and
SHALLOL DC902P is a product from Dai-ichi Kogyo Seiyaku Co., Ltd.

As is apparent from Table 1, the inkjet recording medium of the present invention can achieve high glossiness and high printing density. Moreover, occurrence of coating defects is suppressed in the inkjet recording medium of the present invention.

Accordingly, the present invention can provide an inkjet recording medium that can realize higher glossiness and higher printing density, as well as more suppressed occurrence of coating defects, compared to conventional inkjet recording media having a multi-layer structure including an inkjet receiving layer containing pseudo-boehmite alumina.

All publications, patent applications, and technical standards mentioned in this specification are herein incorporated by reference to the same extent as if each individual publication, patent application, or technical standard was specifically and individually indicated to be incorporated by reference.

What is claimed is:

1. An inkjet recording medium, comprising at least a first ink-receiving layer and a second ink-receiving layer on a support, the first ink-receiving layer being positioned farthest from the support and containing pseudo-boehmite alumina, and the second ink-receiving layer being positioned between the first ink receiving layer and the support and containing a water-soluble polyvalent metal salt and fumed silica that is dispersed using the water-soluble polyvalent metal salt.

2. The inkjet recording medium according to claim 1, wherein the fumed silica is dispersed using the water-soluble polyvalent metal salt in an amount of from 3 to 30% by mass with respect to the amount of the fumed silica.

3. The inkjet recording medium according to claim 1, wherein the fumed silica is dispersed using the water-soluble polyvalent metal salt and an organic cationic polymer having an I/O value of 2.2 or more in an amount of 20% by mass or less with respect to the amount of the water-soluble polyvalent metal salt.

4. The inkjet recording medium according to claim 2, wherein the fumed silica is dispersed using the water-soluble polyvalent metal salt and an organic cationic polymer having an I/O value of 2.2 or more in an amount of 20% by mass or less with respect to the amount of the water-soluble polyvalent metal salt.

5. The inkjet recording medium according to claim 1, wherein an average diameter of primary particles of the fumed silica is from 3 to 50 nm.

6. The inkjet recording medium according to claim 1, wherein the water-soluble polyvalent metal salt is a water-soluble metal salt of aluminum or an element in the IVa group in the periodic table.

7. The inkjet recording medium according to claim 6, wherein the water-soluble polyvalent metal salt is a basic poly aluminum hydroxide compound.

8. The inkjet recording medium according to claim 1, wherein at least one of the first ink-receiving layer and the second ink-receiving layer contains a water-soluble binder.

9. The inkjet recording medium according to claim 1, wherein at least one of the first ink-receiving layer and the second ink-receiving layer contains a crosslinking agent.

10. A method of manufacturing an inkjet recording medium comprising forming a coating layer on a support by applying a coating composition for forming a first ink-receiving layer containing pseudo-boehmite alumina and a coating composition for forming a second ink-receiving layer containing fumed silica that is dispersed using a water-soluble polyvalent metal compound, the coating composition for forming the first ink-receiving layer and the coating composition for forming the second ink-receiving layer being applied silmultaneously such that the coating composition for forming the first ink-receiving layer is applied over the coating composition for forming the second ink-receiving layer.

11. The method of manufacturing an inkjet recording medium according to claim 10, further comprising, after the application, drying the coating layer such that the drying comprises a stage at which the film surface temperature of the coating layer becomes less than 20° C.

12. The method of manufacturing an inkjet recording medium according to claim 11, wherein the stage at which the film surface temperature of the coating layer becomes less than 20° C. occurs immediately after the initiation of the drying.

13. The method of manufacturing an inkjet recording medium according to claim 10, wherein the drying is performed at a temperature of from 60 to 200° C.

14. The method of manufacturing an inkjet recording medium according to claim 10, wherein the fumed silica is dispersed using the water-soluble polyvalent metal salt in an amount of from 3 to 30% by mass with respect to the amount of the fumed silica.

15. The method of manufacturing an inkjet recording medium according to claim 10, wherein the fumed silica is dispersed using the water-soluble polyvalent metal salt and an organic cationic polymer having an I/O value of 2.2 or more in an amount of 20% by mass or less with respect to the amount of the water-soluble polyvalent metal salt.

16. The method of manufacturing an inkjet recording medium according to claim 10, wherein an average diameter of primary particles of the fumed silica is from 3 to 50 nm.

17. The method of manufacturing an inkjet recording medium according to claim 10, wherein the water-soluble polyvalent metal salt is a water-soluble metal salt of aluminum or an element in the IVa group in the periodic table.

18. The method of manufacturing an inkjet recording medium according to claim 17, wherein the water-soluble polyvalent metal salt is a basic poly aluminum hydroxide compound.

19. The method of manufacturing an inkjet recording medium according to claim 10, wherein at least one of the coating composition for forming the first ink-receiving layer or the coating composition for forming the second ink-receiving layer contains a water-soluble binder.

20. The method of manufacturing an inkjet recording medium according to claim 10, wherein at least one of the coating composition for forming the first ink-receiving layer and the coating composition for forming the second ink-receiving layer contains a crosslinking agent.
